(19) United States
(12) Patent Application Publication
(10) Pub. No.: US 2023/0096887 A1
(43) Pub. Date: Mar. 30, 2023

(54) PREDICATED PACKET PROCESSING IN NETWORK SWITCHING DEVICES

(71) Applicant: NVIDIA Corporation, Santa Clara, CA (US)

(72) Inventors: Stephen Warren, Fort Collins, CO (US); Krishna Garlapati, Los Gatos, CA (US)

(21) Appl. No.: 17/529,637

(22) Filed: Nov. 18, 2021

Related U.S. Application Data
(60) Provisional application No. 63/261,809, filed on Sep. 29, 2021.

(51) Int. Cl. G06F 8/30; H04L 29/06

(52) U.S. Cl. CPC G06F 8/315; H04L 69/22

(57) ABSTRACT

Apparatuses, systems, and techniques to operate a network switching device using predicated instructions that implement conditional algorithms of data packet processing are disclosed. The disclosed techniques relate to compiling source codes into objects codes for execution on target network switching devices as well as the actual execution of such compiled object codes. Compilation of a source code may include identifying conditional instructions (CIs) in the source code, which specify contingent actions to be performed by the NSD on a data packet, and compiling the identified CIs to generate corresponding sets of predicated instructions (PIs) of the object code executable by the NSD.

### RELATED APPLICATIONS

This application claims the benefit of U.S. Provisional Application No. 63/261,809, filed Sep. 29, 2021, the entire contents of which is being incorporated herein by reference

### TECHNICAL FIELD

At least one embodiment pertains to processing resources and techniques to perform and facilitate network switching operations. For example, at least one embodiment pertains to processing of packets in network switching devices using predicated operations to implement conditional branches of packet handling algorithms. Systems and methods, according to various novel techniques described herein, support efficient packet routing operations for complex multi-device environments.

### BACKGROUND

Network switching devices (or network switches, as used herein for brevity) connect various other devices, such as computers, servers, memory stores, peripheral devices, and the like, communicate data packets among the devices, enforce access rights, and facilitate efficient and correct processing and forwarding of data packets. Network switches can have multiple input and output ports, memory units that store instructions defining access rights and various processing actions, and processing logic that compares packet metadata to pertinent rules in the instructions and performs suitable actions on the packets, including forwarding the packets to correct destinations, rejecting packets that arrive from untrusted sources, combining and splitting the packets, and so on.

### BRIEF DESCRIPTION OF DRAWINGS

FIG. 1 illustrates a high-level hardware architecture of a network switch that implements predicated instructions for packet processing, in accordance with at least some embodiments;

FIG. 2 is a schematic illustration of a predicated processing of a packet by a network switch (e.g., the network switch of FIG. 1) operating in accordance with at least some embodiments;

FIG. 3A depicts schematically a predicated processing of nested conditional operations by a network switch, in accordance with at least some embodiments;

FIG. 3B depicts schematically the order of execution of the predicated instructions arranged via a plurality of match action tables described in relation to FIG. 3A, in accordance with at least some embodiments;

FIG. 4 illustrates operations of a compiler that generates an object code that implements predicated instructions for packet processing on a network switch, based on an input source code, in accordance with at least some embodiments;

FIG. 5 is a flow diagram of an example method of compiling an object code that implements predicated instructions for packet processing on a network switch, based on an input source code, in accordance with at least some embodiments;

FIG. 6 is a flow diagram of an example method of deploying a compiled code that implements predicated instructions for packet processing on a network switch, in accordance with at least some embodiments.

### DETAILED DESCRIPTION

The processing logic of network switches can perform complex instructions that implement multiple actions on arriving data packets before the data packets are forwarded to their intended destinations. Such instructions can include unconditional instructions, e.g., copying header information of an arrived packet into a register. In addition, the processing logic can execute many conditional instructions that have two or more branches whose execution is contingent upon occurrence of certain conditions. For example, a packet that arrives from a first TCP/IP address can be rejected; a packet that arrives from a second TCP/IP address can be forwarded to one set of devices but not to another set of devices; a packet that arrives from a third TCP/IP address can be forwarded to only a specific device and only if the packet header specifies the destination address of that specific device, otherwise, the packet is rejected; and so on.

Data flows that have conditional branches can be implemented using conditional instructions. For example, if Action 1 is to be taken provided that Header of a packet has value 010 and Action 2 is to be taken provided that Header has any other value, with Action 3 to be taken after either Action 1 or Action 2, the code executed by the processing logic can include the following instructions:

```
  Reg0 = Header
  If (Reg0 = 010) GoTo Address 1
  Action 2
  GoTo Address 2
Address 1:
  Action 1
Address 2:
  Action 3
```

In various network switches, the number of available addresses and, respectively, GoTo instructions that can be utilized, is often limited. Therefore, it can be difficult to program a complex set of instructions for a large system or a network of many computers and devices. Such complex sets of instructions may have many branches that are contingent on an occurrence of multiple conditions. Furthermore, branching instructions complicate and slow down pipelined processing of packets.

Aspects and embodiments of the present disclosure address these and other limitations of the present technology by enabling predicated processing of packets in network switching devices. Predicated processing involves a linear flow of instructions whose execution (or non-execution) is contingent (predicated) on the occurrence (or non-occurrence) of specified conditions. Considering the previous example, a predicated execution of the same instructions can be performed as follows:

| | |
|---|---|
| [ ] | Reg0 = Header |
| [Reg0 = 010 ] | Action 1 |
| [Reg0 =/= 010 ] | Action 2 |
| [ ] | Action 3 |

Herein, the first column lists a predicate (triggering condition) to an action. The second column prescribes a specific action that is to be taken if the predicate is satisfied. More specifically, the first operation is an unconditional (no predicate specified) operation of storing the value of Header in register Reg0, the second line causes Action 1 to be performed if Header has value 010, the third line causes alternate Action 2 to be taken provided that Header does not have value 010, and the fourth line causes performance of unconditional Action 3 to be taken after either Action 1 or Action 2. As a result, all actions on the packet are performed in a linear fashion with no jumps occurring between different addresses. As described in more detail below, predicated instructions may be efficiently implemented using tables, alternatively referred to as match action tables (MATs) herein, grouping together various actions that may be performed on the same packet. MATs can be grouped into MAT groups.

The advantages of the disclosed predicated processing include but are not limited to improved ability to implement complex instructions that support numerous conditions for packet routing in systems containing a large number of devices with a large number of potential users, applications, unique data routes, access restrictions, and the like. Predicated processing is also advantageous for pipelined processing of data packets since each data packet is making a linear progression within each MAT group. Moreover, processing of predicates is generally faster than processing of conditional Boolean operations, since many of the predicates can be performed by a simple hardware bit comparator. Predicated instructions allow for a much larger variety of conditions to be implemented, including implementation of operations that are contingent upon simultaneous occurrence of multiple conditions. Furthermore, disclosed implementations enable parallel processing of multiple predicated instructions at the same time. For example, predicated instructions may include multiple entries (branches) with one of the entries being actionable (condition satisfied) and other entities being non-actionable (condition not satisfied). In those implementations, where, at most, one of the entries has an action that is executed on a data packet, no action interference occurs when various entries are processed in parallel.

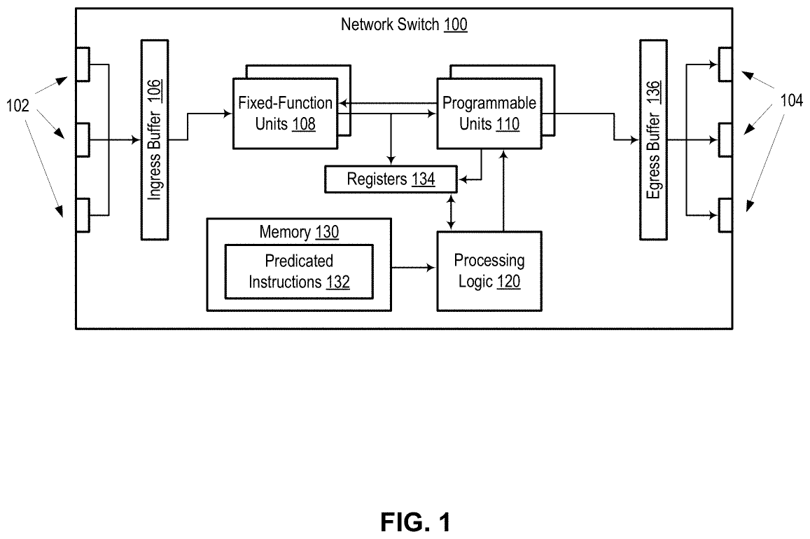

FIG. 1 illustrates a high-level hardware architecture of a network switch 100 that implements predicated instructions for packet processing, in accordance with at least some embodiments. Data packets may enter the network switch 100 through one or more ingress ports 102 and leave through one or more egress ports 104. Entering data packets may be stored, e.g., during pipeline processing of packets, in an ingress buffer 106. Network switch 100 may include one or more fixed-function units 108 and one or more programmable units 110. Fixed-function units 108 may perform a number of actions on incoming or outgoing packets, e.g., encrypting packets, reading and writing packet headers, copying packets, and so on. Programmable units 110 may perform operations that are responsive to specific settings of the network switch 100 and/or the system/network of devices supported by network switch 100, e.g., actions involving routing packets, authenticating packets, selecting encryption/decryption keys for the packets, enforcing access rules, splitting and/or, merging packets, and so on. Programmable units 110 may be controlled by processing logic 120 that outputs control signals causing programmable units 110 to perform a particular function or action selected by processing logic 120. Signals that are output by processing logic 120 may be caused by instructions stored in memory 130. At least some of the instructions may be or include predicated instructions 132 that enable linear processing of conditional operations, as described in more detail below.

Network switch 100 may also include a plurality of registers to store some of the packet data (e.g., packet headers). Predicate instructions may be programmed to depend on the values stored in registers 134. Processing logic 120 may be capable of reading the content of registers 134, comparing the content to conditions in the predicated instructions 132 and selecting one or more actions to be performed on the packet using programmable units 110 (or fixed function units 108). Programmable units 110 and/or processing logic 120 may be capable of changing the content of registers 134 (e.g., of the data stored therein) as well as the content of data packets. Processing logic 120 may perform, e.g., using programmable units 110, processing of packets that involves multiple rounds of packet processing (e.g., packet modifications). In some embodiments, a given packet may be modified or routed differently depending on data contained in the headers of other packets, e.g., packets that have been previously processed by network switch 100 or packets that are being processed concurrently with the given packet. Processing logic 120 may include any type of a processing device, including but not limited to a central processing unit (CPU), application-specific integrated circuit (ASIC), field-programmable gate array (FPGA), a finite state machine (FSM), or any combination thereof. In some implementations, processing logic 120 may be implemented as part of an integrated circuit that includes memory 130. Memory 130 may include a read-only memory (ROM), a random-access memory (RAM), a dynamic RAM (DRAM), a static RAM (SRAM), a high-speed cache memory, flip-flop memory, or any combination thereof.

Processed packets may be stored temporarily in the egress buffer 136 before being output through one (or more) egress ports 104. Although a certain order of fixed-function units 108 and programmable units 110 is depicted in FIG. 1, as an example, it should be understood that additional fixed-function operations (e.g., encryption operations) may also be performed after processing by programmable units 110, or even after storage in the egress buffer 136. In some implementations, processing with fixed-function units 108 can be interleaved with processing by programmable units 110.

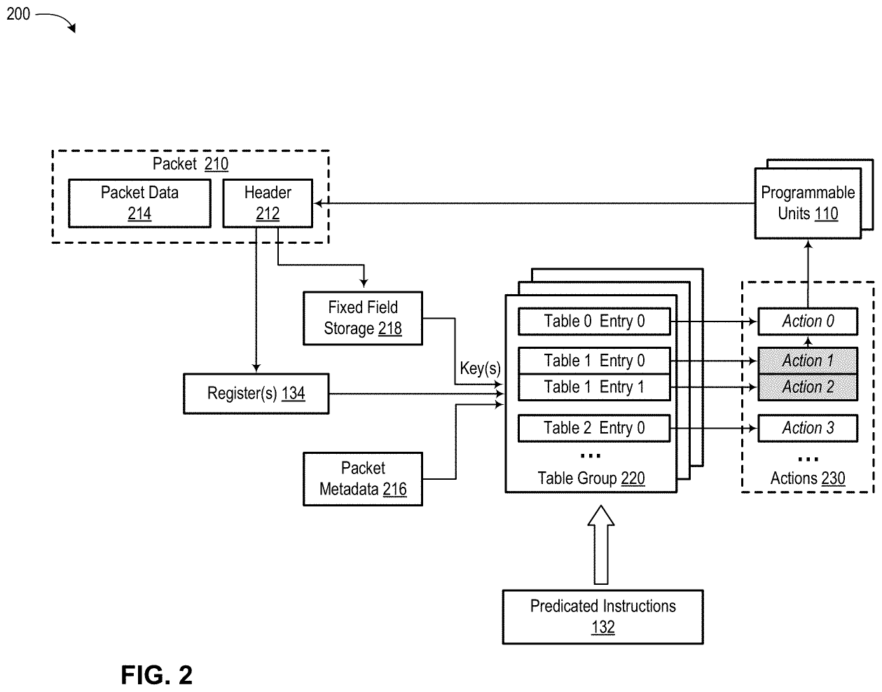

FIG. 2 is a schematic illustration of predicated processing 200 of a packet by a network switch (e.g., network switch 100 of FIG. 1) operating in accordance with at least some embodiments. A received packet 210 may include a header 212 and packet data 214. Header 212 may include various packet-identifying information, such as an address of a source of packet 210, e.g., an IP address of a device that created (or forwarded) packet 210, an address of a destination of packet 210, e.g., an IP address of a device that is an intended final (or intermediate) recipient of packet 210, a time stamp indicating the time of creation (or forwarding) of packet 210, an indication of a cryptographic key that is used to encrypt packet 210, or any other packet-identifying information. Information from header 212 may be read by the network switch (e.g., by one of the fixed-function units 108 of network switch 100). In some embodiments, the information from header 212 may be stored in one or more registers 134 and/or in a fixed field storage 218. Predicated instructions (as described in more detail below) may be contingent upon values of various keys derived from registers 134, fixed field storage 218, and/or packet metadata 216. A “key” refers to any predetermined set of one or more memory units (e.g., bits), e.g., any predetermined portion (or multiple portions) of registers 134 and/or fixed field storage 218, and/or packet metadata 216. Different predicated instructions may be contingent upon values of different keys. A given key may be as short as one bit or as long as hundreds (or more) of bits. A “key value” refers to a numerical value (e.g., 01101001) currently stored in such predetermined memory units. For example, a first predicated instruction may be contingent on a first key value that is stored in a 16-bit Register 0, a second predicated instruction may be contingent on a second key value that is stored in the most significant bit of Register 1; a third predicated instruction may be contingent on a third key value that is a 128-bit value of header 212 stored in fixed field storage 218; and so on. Any number of keys, e.g., Key 1, Key 2 . . . etc., may be defined for a given packet 210 and packet metadata 216, e.g., derived from different portions of header 212 and/or packet metadata 216, or obtained using different combinations of such portions. For example, Key 1 may include packet 210 source identification (ID) and the time of the packet creation; Key 2 may include destination ID of packet 210 and an ingress port of packet 210, Key 3 may include a single bit indicating whether packet 210 was created by a trusted application, and so on.

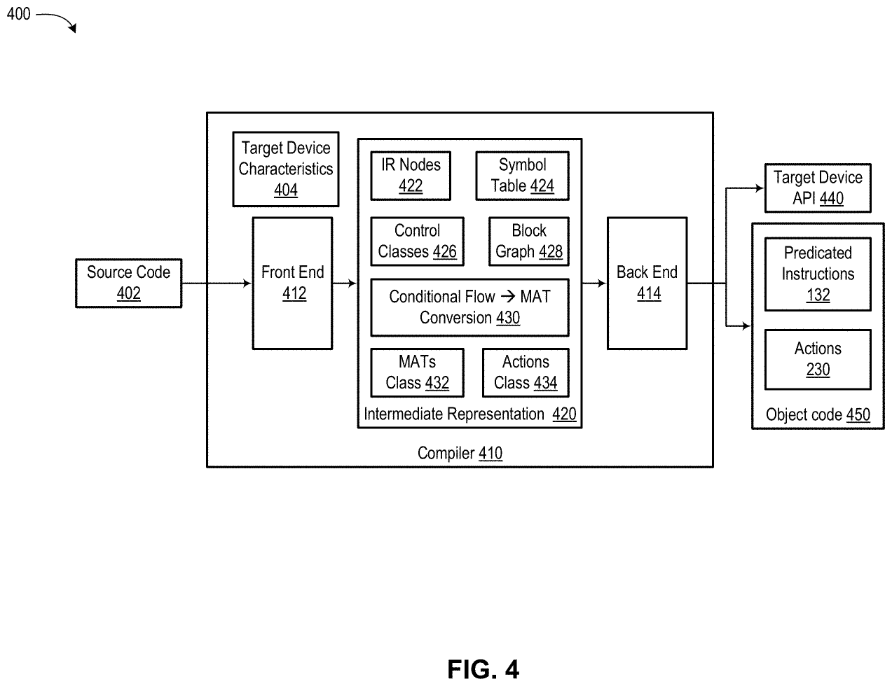

Generated keys may be used during execution of predicated instructions 132 that may be arranged via a set of match action tables (MATs) generated by a compiler (as described in more detail below in conjunction with FIG. 4). MATs, herein also sometimes referred to as “tables” for brevity, may be combined into MAT groups or, simply, table groups. A table group 220 is depicted schematically in FIG. 2. Each table may include a preamble that identifies the table, e.g., by an ID of the table (e.g., Table 0, Table 1, etc.) within a respective table group as well as by the ID of the table group (e.g., Table Group 0, Table Group 1, etc.). The preamble may further identify a set of keys {Key}=(Key1, Key2, . . . ). In some embodiments, the keys of the set may be identified by memory addresses that store corresponding key values. The sets of keys {Key} may include one or more keys whose key values determine what actions specified within the table may have to be performed. More specifically, a table may further include one or more entries (rules) that specify an action that is to be performed on packet 210 or any portion thereof (e.g., header 212), provided that the set of keys {Key} has values specified in the respective entry. In some implementations, a table may have any number of entries, each entry being associated with a specific action. Among the actions associated with various entries of a table, one action may be selected for execution based on matching of the run-time values of the set of keys {Key} to the key values specified in the respective entry. Since, at most, one of the entries of a table has an action that is executed, no action interference occurs when various entries in the same table are processed in parallel. Various tables within a table group may be executed in a sequential order, e.g. starting from Table 0, Table 1, and so on. Different table groups may be executed in an arbitrary order based on flow control instructions executed by processing logic 120.

Some or all actions specified in the entries of a table may be predicated on a fulfilment of a condition whose occurrence or non-occurrence may be established from a value of a key (or a set of keys) associated with the particular entry. For example, Table 0 may include one entry, e.g., Entry 0, instructing the processing logic to perform unconditional Action 0, e.g.,

TABLE 0

```
Keys: [ ]
Entry 0:
  Key match values: [ ]
  Action: Action 0
```

This instruction specifies, in the first line, the table ID (Table 0) within a particular table group (e.g., table group N). In the second line, the instruction identifies one or more keys whose current values are used as predicates for Table 0 actions. No keys are specified for Table 0 indicating that the action of Table 0 is unconditional. The last line specifies that the action to be performed is Action 0.

As another example, execution of the conditional code

```
  Reg0 = Header
  If (Reg0 = 010) GoTo Address 1
  Action 2
  GoTo Address 2
Address 1:
  Action 1
Address 2:
  Action 3
```

discussed earlier, may be implemented using MAT-based predicated instructions as follows:

TABLE 1

```
Keys: [ Reg0 ]
Entry 0:
  Key match values: [ 010 ]
  Action: Action 1
Entry 1:
  Key match values: [ not 010 ]
  Action: Action 2
```

TABLE 2

```
Keys: [ ]
Entry 0:
  Key match values: [ ]
  Action: Action 3
```

This instruction first deploys Table 1 and identifies the key via its storage location (register Reg0). The specified MAT has multiple entries (Entries 0 and 1). Entry 0 specifies that Action 1 is to be performed if the value stored in Reg0 is 010. Entry 1 specifies that Action 2 is to be performed if the value stored in Reg0 is not equal to 010. The instruction then deploys Table 2, which specifies that Action 2 is performed unconditionally. In some embodiments, entries 0 and 1 may be executed in parallel, by different processing threads.

Scheduling and execution of conditional (shaded boxes) and unconditional (white boxes) actions 230 is depicted schematically in FIG. 2. For a given instance of Table 1 processing, only one of Action 1 or Action 2 is performed and no address hopping occurs. Scheduled actions 230 can be performed, in a linear progression, by one or more programmable units 110. In some instances, the actions (as depicted schematically with a leftward arrow) can modify one or more of destinations of packet 210, priority of delivery of packet 210, cryptographic status of packet 210 (e.g., encrypted or unencrypted), quarantining of packet 210, and the like. For example, Action 1 may include redirecting the packet to a specific port of the networks switch 100; Action 2 may include forwarding the packet based on a stored (in memory 130 of network switch 100) IP routing table, etc.

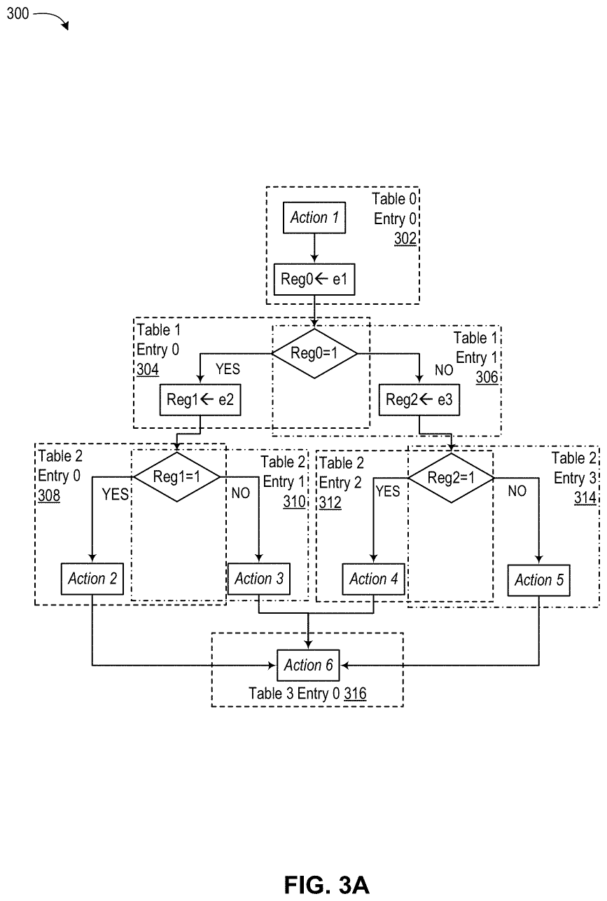

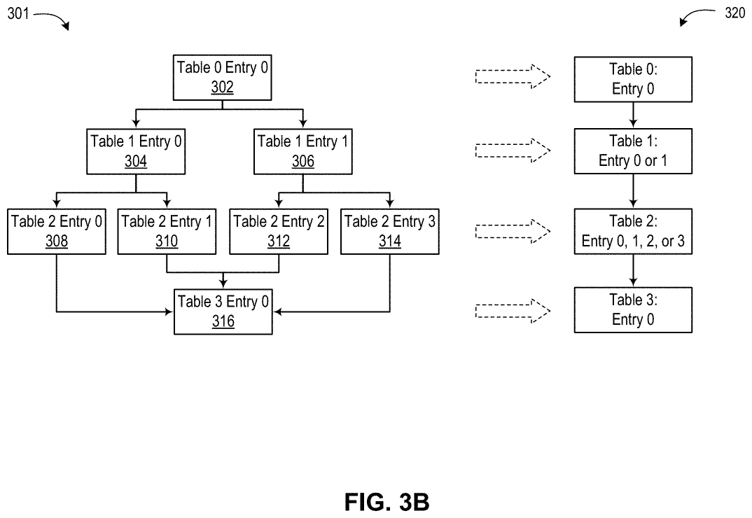

FIG. 3A depicts schematically a predicated processing 300 of nested conditional operations by a network switch, in accordance with at least some embodiments. The nested conditional operations depicted in FIG. 3A execute the following example nested code:

```
Action 1;
If (e1 = 1)
  If (e2 = 1)
    Action 2
  Else
    Action 3
Else
  If (e3 = 1)
    Action 4
  Else
    Action 5
Action 6
```

The flow chart in FIG. 3A shows the flow of processing with value e1 stored in register Reg0, value e2 stored in register Reg1, and value e3 stored in register Reg2. The following MAT-based predicated instructions may implement this nested code:

TABLE 0

```
Keys: [ ]
Entry 0:
  Key match values: [ ]
  Action: Action 1
    Reg0=e1
```

TABLE 1

```
Keys: [ Reg0 ]
Entry 0:
  Key match values: [ 1 ]
  Reg1=e2
Entry 1:
  Key match values: [ 0 ]
  Reg2=e3
```

TABLE 2

```
Keys: [ Reg0, Reg1, Reg2 ]
Entry 0:
  Key match values: [ 1, 1, NA ]
  Action: Action 2
Entry 1:
  Key match values: [ 1, 0, NA ]
  Action: Action 3
Entry 2:
  Key match values: [ 0, NA, 1 ]
  Action: Action 4
Entry 3:
  Key match values: [ 0, NA, 0 ]
  Action: Action 5
```

TABLE 3

```
Keys: [ ]
Entry 0:
  Key match values: [ ]
  Action: Action 6
```

As indicated, this instruction includes four tables, Tables 0, 1, 2, and 3 that specify various actions and decision-making blocks of the flow chart in FIG. 3A. Each of the decision-making blocks is shared between two entries of a corresponding table.

More specifically, Table 0 has a single Entry 0 (302) that performs unconditional Action 1 and additionally loads value e1 (e.g., from the header of a packet) to register Reg0 for use in the subsequent tables.

Table 1 operations depend on the value of the key loaded in register Reg0. Table 1 has Entries 0 and 1. Entry 0 (304) specifies that value e2 is to be loaded into register Reg1, if the value stored in Reg0 is 1 (to begin execution of the nested block that includes Action 2 and Action 3). Entry 1 (306) specifies that value e3 is to be loaded into register Reg2, if the value stored in Reg0 is 0 (to begin execution of the nested block that includes Action 4 and Action 5).

Table 2 operations depend on the value of the keys loaded in registers Reg0, Reg1, and Reg2. Table 2 has Entries 0, 1, 2, and 3. Entry 0 (308) is executed if e1=1 and e2 =1 and performs Action 2 (regardless of the value e3). Entry 1 (310) is executed if e1=1 and e2=0 and performs Action 3 (regardless of the value e3). Entry 2 (312) is executed if e1=0 and e3=1 and performs Action 4 (regardless of the value e2). Finally, Entry 3 (314) is executed if e1=0 and e3=0 and performs Action 5 (regardless of the value e2).

Table 3 has a single Entry 0 (316) that performs unconditional Action 6 that does not depend on any key values.

The use of two registers Reg1 and Reg2 in this example is for the ease of presentation. Since registers Reg1 and Reg2 are used in disjointed operations, it is sufficient to use only one register (e.g., Reg1), which may store either value e2 or value e3, depending on the key values stored in register Reg0.

For conciseness, the key match values in the example above have binary form (e.g., are 0 or 1). In various implementations, any Boolean operation may be included as part of identifying the key values, e.g., “key value less than 5,” or the like. In some instances, the key value may itself be identified as a result of some evaluation procedure (that may include one or more computations and/or functions) that is specified as part of the key match value.

FIG. 3B depicts schematically the order of execution 301 of the predicated instructions arranged via a plurality of match action tables described in relation to FIG. 3A, in accordance with at least some embodiments. As depicted schematically with a linear processing flow 320, each table may select one Entry for execution. As a result, one of the Actions 2, 3, 4, or 5 is performed after Action 1 and prior to Action 6, without address hopping. Operations depicted in FIG. 3B may be performed by two or more (e.g., four) processing threads. For example, if two processing threads, Thread 1 and Thread 2, are available, Thread 1 may execute actions specified in Entry 0 of Table 0 and Entry 1 304 of Table 1 (if the corresponding predicate is met) and Thread 2 may execute actions specified in Entry 1 306 of Table 1 and Entry 0 316 of Table 3 (if the corresponding predicate is met). Thread 1 and Thread 2 may split execution of Entries 308-314 of Table 2 in any possible manner, e.g., with Entry 0 308 and Entry 1 310 performed by Thread 1 and Entry 2 312 and Entry 3 314 performed by Thread 2. In some embodiments, when pipeline processing is used, Thread 2 may perform actions of Entry 0 316 of Table 3 concurrently with Thread 1 performing actions of Entry 0 302 of Table 0 for the next data packet. Numerous other ways to parallelize execution of various entries and tables may be devised, based on specifics of the source code that is being implemented. In the above example, “threads” should be understood as any software processes or hardware devices that enable parallel processing of instructions, including different software threads, physical processor cores, virtual processor cores, and the like.

FIG. 4 illustrates operations 400 of a compiler that generates an object code that implements predicated instructions for packet processing on a network switch, based on an input source code, in accordance with at least some embodiments. As depicted in FIG. 4, a compiler 410 may use a source code 402, written in any suitable high-level programming language (e.g., P4 programming language), used as an input, and a set of target device characteristics 404, which may similarly be used as an input into compiler 410 or may be pre-loaded and stored as part of compiler 410 (as depicted in FIG. 4). Compiler 410 may include a front end module 412 to parse the source code 402; an intermediate representation (IR) module 420, to represent the content of the source code 402 via universal data structures (e.g., as C++ data structures); and a back end module 414 to implement the IR data structures on a specific hardware of the target device.

The IR module 420 can represent the source code 402 via a set (graph) of IR nodes 422. The IR nodes may represent information as semantically as possible, rather than in a manner more oriented at the generic high-level programming syntax. For example, for a MAT property that represents a desired minimum table size, IR module 420 may provide a dedicated integer field to hold the minimum data, rather than a generic key/value list of arbitrary properties and values with arbitrary expression types. The IR nodes may be represented in a self-contained fashion. For example, an IR node may include an identification of a pipeline to which the node belongs, rather than requiring algorithms to look up such information in a side-band data structure or via a separate function. IR nodes may be joined in a tree structure with each node referencing both downstream nodes (child nodes) and upstream nodes (parent nodes). Each node may have a unique ID.

The IR module 420 may generate a symbol table 424 that contains definition of some or all symbols in the compiled code, both within a global scope and various local scopes. This enables a symbol lookup using a single table. Symbols may include variable declarations and extern instantiations. Declarations may describe scalar variables and may include a bit size, register allocation details, e.g., a list of annotations relevant to register allocation, logical and physical register numbers, and so on. Extern instantiations may describe instances of extern classes (extern objects) and may include specifications of a number of counters associated with an object, types of event being counted (e.g., packets, bytes), and so on.

The IR module 420 may generate control classes 426, where the primary behavior of the code is specified. Control classes 426 may include extern function calls, table apply operations, and various conditions. Control classes 426 may reference a block graph 428 and a list of MATs. Block graph 428 may represent some or all executed statements in the code. Various portions of the code may be divided into blocks, each block representing one or more instructions that may be executed linearly under similar conditions. Block graph 428 may further define entry and exit points into each block. Each block may further describe its predecessors and successors within the block graph 428. Block graph 428 may further specify a set of various paths of execution between different blocks.

Compiler 410 may further include a module 430 that translates conditional control flow into a set of match action tables class 432, e.g., as described above in conjunction with FIG. 2 and FIGS. 3A-B. MAT class 432 may represent various aspects of match action tables. Each table may include, among other things, i) a set of keys that are used during lookup of table entries, ii) a set of actions that may be performed as part of a table entry, iii) a definition of a default action that executes if no matching table entry is found, iv) any parameters of the actions, v) a list of initial (“constant”) entries that may be added to the table when the compiled code is initially executed, and so on.

Compiler 410 may further include an actions class 434 that represents some or all aspects of a particular action executed as part of the compiled code. When a table entry's keys match the values specified in the entry, the entry's action is invoked, and the entry's parameters are passed to a device that performs the action (e.g., to one or more programmable units 110). Action class 434 may be structured similar to block graph 428, e.g., as a graph of action blocks each containing a list of statements. In addition, each action block may have a list of parameters provided by the relevant table entry that caused the respective actin to be executed.

Compiler back end 414 may configure a compiled object code 450 for execution on a specific target (network switching device) in view of the target device characteristics 404, e.g., various hardware capabilities of the target device, which may include processing resources, memory resources, a number of ingress and egress ports, a number of tables (MATs) and table groups that may be supported by the target device, and the like. Object code 450, when executed by the target device, may perform various predicated instructions 132 and actions 230, which may operate as described above in conjunction with FIGS. 1-3. In some implementations, compiler 410 may further generate a target-device specific application programming interface (API) 440 to enable user interaction with the target device executing compiled object code 450.

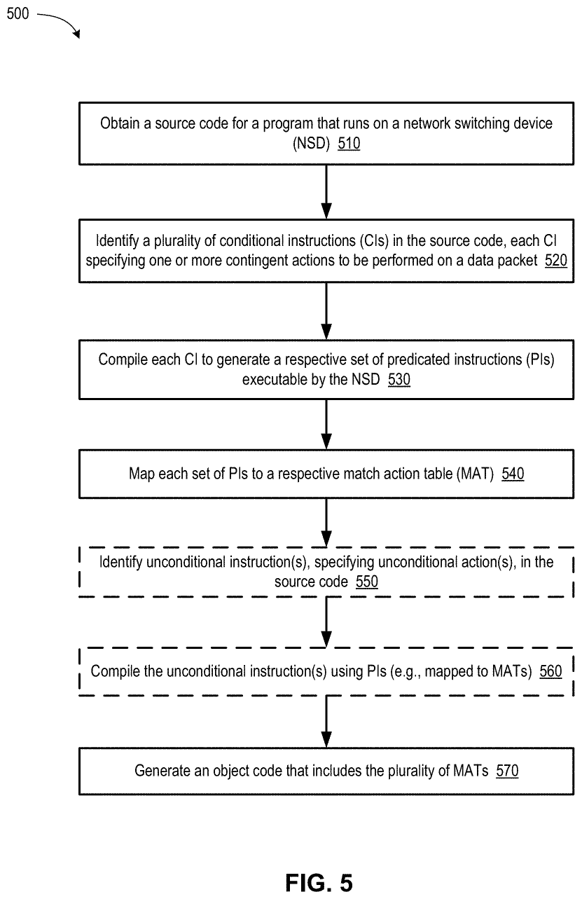

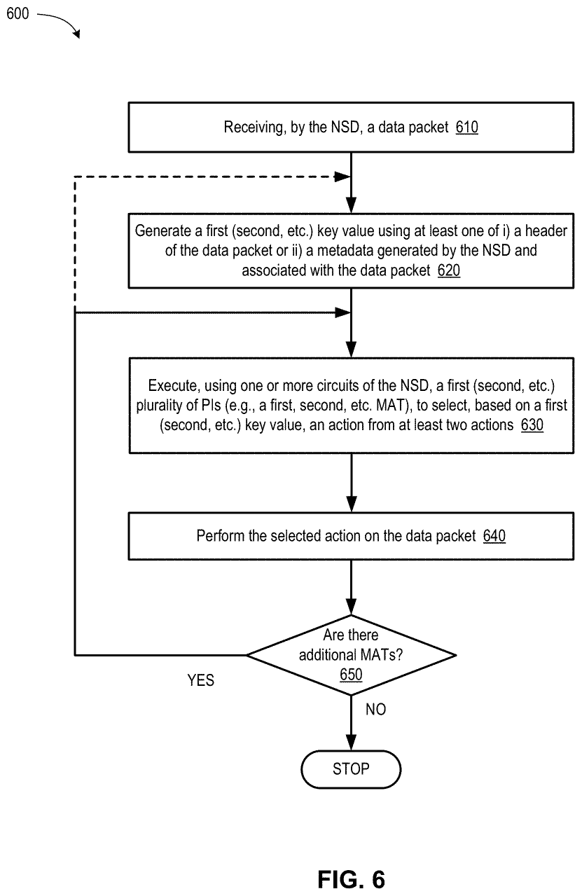

FIG. 5 and FIG. 6 are flow diagrams of example methods 500 and 600, respectively, of using predicated instructions for efficient deployment of network switching devices, in accordance with at least some embodiments. In some embodiments, method 500 may be performed to compile a code for a program that runs on a network switching device. For example, compiling such a code may be performed by a compiler 410 of FIG. 4. In some embodiments, method 600 may be performed by executing the compiled code (e.g., object code) on a network switch 100 of FIG. 1. In some embodiments, methods 500 and 600 may be performed by one or more circuits that may communicate with one or more memory devices. In some embodiments, at least some operations of methods 500 and 600 may be performed by multiple (e.g., parallel) hardware threads, each thread executing one or more individual functions, routines, subroutines, or operations of the methods. In some embodiments, processing threads implementing methods 500 and 600 may be synchronized (e.g., using semaphores, critical sections, and/or other thread synchronization mechanisms). Alternatively, hardware threads implementing each of methods 500 and 600 may be executed asynchronously with respect to each other. Various operations of methods 500 and 600 may be performed in a different order compared with the order shown in FIG. 5 and FIG. 6. Some operations of methods 500 and 600 may be performed concurrently with other operations. In some embodiments, one or more operations shown in FIG. 5A and FIG. 6 may not be performed.

FIG. 5 is a flow diagram of an example method 500 of compiling an object code that implements predicated instructions for packet processing on a network switch, based on an input source code, in accordance with at least some embodiments. Method 500 may be performed by any suitable processing logic (e.g., CPU, FPGA, etc.) of a computing device that hosts (and executes) compiler 410 of FIG. 4. Method 500 may be used to generate an object code configured to operate a network switching device (NSD) for processing of data packets. Method 500 may include obtaining, at block 510, a source code. The source code may be written in any suitable programming language (e.g., C/C++, P4, etc.) and may specify any number of operations that are to be performed during processing of data packets transferred between any computing devices connected via a network switch to Internet, a wide area network, a local area network, a personal area network, or any combinations thereof. The source code may specify rules of processing of data packets transferred between computing devices connected to the NSD using any suitable wired connections, wireless connections, or any combination thereof.

At block 520, method 500 may continue with identifying a plurality of conditional instructions (CIs) in the source code. Each of the plurality of CIs may specify one or more contingent actions to be performed by the NSD on a data packet. A given CI may specify any number of operations that are to be performed upon occurrence (or non- occurrence) of any number of conditions. In some instances, a CI may specify a single action A₁ that is to be performed upon occurrence of a condition C₁, with no action to be taken if condition C₁ does not occur. In some instances, a CI may specify two actions A₁ and A₂ with action A₁ to be performed upon occurrence of a condition C₁, and action A₂ to be performed otherwise. In some instances, a CI may specify three actions A₁, A₂ and A₃, with action A₁ to be performed upon occurrence of condition C₁ but not condition C₂, action A₂ to be performed upon occurrence of condition C₁ together with condition C₂, and action A₃ to be performed upon non-occurrence of condition C₁ (regardless of occurrence of condition C₂). Practically unlimited number of different types of conditions may be specified in any given CI.

In some embodiments, a CI may be a nested CI of n-th order, having n levels of branching conditions (e.g., binary conditions). More specifically, a first (j=1) level condition may branch the processing flow into two branches, two second (j=2) level conditions may further split each branch into two additional branches (for the total 2²=4 of branches), and so on, with 2^{j-1} conditions of j-th level producing 2^{j} branches. The last level of 2ⁿ⁻¹ conditions may produce 2ⁿ branches, each branch specifying one of 2ⁿ possible contingent actions. An example of a nested CI of second order is illustrated in FIG. 3A. Any number of 2ⁿ actions may be a void action (a non-action), such that no action is taken as part of this particular nested CI (with other actions, possibly, to be performed on the same data packet, specified in other, conditional or unconditional, instructions). The described nested CI is but one example of a possible class of nested CI. In particular, a nested CI need not have all branches of the same length (counted as a number of decision-making points or conditions). For example, some branches may have length 1 (e.g., a single decision-making point or condition leading to the corresponding contingent action), while some branches may have a maximum length of n (with arbitrary number of branches having length between 1 and n).

At block 530, method 500 may include compiling the identified plurality of CIs to generate a plurality of sets of predicated instructions (PIs) of the object code executable by the NSD. Each of the plurality of sets of PIs may correspond to a respective CI of the plurality of CIs. For example, the following CI,

```
  If (Senior Header Bit = 1) GoTo Address 1
  Action 2
  GoTo Address 2
Address 1:
  Action 1
Address 2: ...
```

may be compiled using a set of PIs, as follows:

| | |
|---|---|
| [ ] | Register M = Senior Header Bit |
| [Register M = 1 ] | Action 1 |
| [Register M = 0 ] | Action 2 |
| . . . | . . . |

In this example, a set of PIs used to represent the CI contains two PIs, but any other number of PIs may be used in various specific instances, including a set that has a single PI. For example, a single PI may be used if no action is to be taken provided that Senior Header Bit has value 0.

At block 540, method 500 may continue with mapping each set of the PIs to a respective match action table (MAT). In particular, the above example may be implemented via a first MAT, as follows:

TABLE 1

```
Keys: [ Register M ]
Entry 0:
  Key match values: [ 1 ]
  Action 1
Entry 1:
  Key match values: [ 0 ]
  Action 2
```

The first MAT (e.g., Table 1) may include a first identification of a key, also referred herein to as a first keyID (e.g., Register M in this example) and a plurality of PI entries. For example, a first PI entry (e.g., Entry 0) of the plurality of PI entries may specify a first action (e.g., Action 1) to be performed by the NSD. The first action may be contingent on a first key value identified by the first keyID (e.g., a current value stored in Register M) being equal to the first target value (e.g., Key match value 1). Similarly, the first MAT may further include a second PI entry (e.g., Entry 1) of the plurality of PI entries specifying a second action (e.g., Action 1) to be performed by the NSD. The second action may be contingent on the first key value (e.g., the current value stored in Register M) being equal to the second target value (e.g., Key match value 0).

It should be understood that the above example is intended for illustration only, and that a set of PIs (e.g., a MAT or table) may include any number of PIs (table entries), e.g., a third PI, a fourth PI, and so on. A keyID (e.g., first keyID) is not limited to identification of registers and may identify any portion of a memory of the NSD, e.g., a portion (that may include one or more bits) of RAM, cache, buffer(s), etc. A key value (e.g., the first key value) may be any value currently stored in the identified portion of the memory of the NSD. In some embodiments, the key value currently stored in the identified portion of the memory of the NSD may be obtained using a header of the data packet, or a metadata generated by the NSD and associated with the data packet, or any combination thereof.

It should also be understood that a single keyID (e.g., the first keyID) in the above example is intended as an illustration and that in some instances multiple keyIDs may be used within the same set of PIs (e.g., the same MAT), such as, second keyID, third keyID, etc. For example, a second MAT (herein referred to as Table 2) may include:

TABLE 2

```
Keys: [ Reg0, Reg1 ]
Entry 0:
  Key match values: [ 1 , 1 ]
  Action: Action 1
Entry 1:
  Key match values: [ 1, 0 ]
  Action: Action 2
Entry 2:
  Key match values: [ 0, 1 ]
  Action: Action 3
Entry 3:
  Key match values: [ 0, 0 ]
  Action: Action 4
```

More specifically, Table 2 in this example includes both a first keyID (Reg0) an a second keyID (Reg1) with actions in Table 2 being contingent on values of both the first keyIDs and the second KeyID. For example, Action 3 is contingent on the first key value being equal to a first target value (e.g., 0) and the second keyID being equal to the second target value (e.g., 1). As illustrated with this example, the first target value may be different than the second target value (as is the case, e.g., for contingent Actions 2 and 3) or the same as the second target value (as is the case, e.g., for contingent Actions 1 and 4).

In some embodiments, CIs identified in the source code may include an n-level (n>1) nested CI specifying 2ⁿ contingent actions to be performed, in alternative, by the NSD. In such embodiments, compiling CIs may include compiling the n-level nested CI to generate a plurality of n match action tables (MATs), e.g., as illustrated in FIG. 3A and FIG. 3B. More specifically, a j-th MAT of the plurality of n MATs may include 2^{j} PI entries. Each of the 2ⁿ PI entries of an n-th MAT of the plurality of n MATs may specify predicated execution of a respective one of the 2ⁿ contingent actions.

A MAT may be implemented using any suitable format recognized by the processing logic of a target NSD. A MAT may be implemented as any sequence of instructions for the processing logic, stored as a binary file, an executable file, a library file, an object file, a memory buffer, encoded into data structures that describe how to generate any of the aforementioned examples, encoded into a program that is capable of generating the MATs during its execution, or the like. Any number of MATs (or groups of MATs) may be stored in a single location/representation/implementation. Similarly, any portion of a given MAT (e.g., one or more MAT entries) may be stored in a separate locations/representations/implementations.

The contingent actions (e.g., the first action, the second action, etc.) to be performed may include, but need not be limited to: a forwarding of the data packet; a rejection of the data packet; a modification of the data packet; a generation of a register value based on the data packet; a generation of a notification about arrival of the data packet, or any combination thereof.

In some embodiments, as indicated by (optional) block 550, generating an object code may include identifying one or more unconditional instructions in the source code. Unconditional instructions may specify one or more unconditional actions to be performed by the NSD on a data packet. In such embodiments, as indicated by (optional) block 560, for uniformity of instructions and data flow, unconditional instructions identified in the source code may also be compiled using PIs. For example, a PI compiled as a MAT (herein referred to as Table 3) may include a null identification of a key and a PI entry specifying the one or more unconditional actions to be performed by the NSD:

TABLE 3

```
Keys: [ ]
Entry 0:
  Key match values: [ ]
  Action: Action 5, Action 6
```

In various embodiments, multiple unconditional actions may be compiled as different entries of Table 3 (or any other applicable MAT), or as entries in separate tables.

At block 570, method 500 may include generating the object code that includes the plurality sets of sets of PIs (e.g., a plurality of MATs). The object code may be in a format that is recognized by the processing device(s) of the target NSD, for a specific target manufacturer, model, series, and so on.

As used throughout this disclosure, the term “object code” includes, but is not limited to, any of the following. Object code includes any binary encoding of the instructions, in any form that may be executed by the NSD or a computing device communicatively coupled to the NSD. Object code may also include any data structure representing the instructions that may be processed by any suitable computing device (e.g., connected to the NSD or separate from the NSD) to generate binary instructions in a form that may be executed by the NSD or a computing device communicatively coupled to the NSD. Object code may further include any program that is capable of generating, e.g., at runtime, binary instructions in a form that may be directly executed by the NSD or a computing device communicatively coupled to the NSD. In some embodiments, the program may be a compiler program that defines a structure of the binary instructions while allowing for portions of the predication values or instruction parameter values (e.g., keyIDs, key match values, etc.) to be provided separately, e.g., after the completion of the compilation process. In some embodiments, any portion of the compiler-generated structure may be instantiated multiple times, e.g., based on data available during processing of data structures and/or execution of the generated object code.

FIG. 6 is a flow diagram of an example method 600 of deploying a compiled code that implements predicated instructions for packet processing on a network switch, in accordance with at least some embodiments. Some operations of method 600 may be performed, at least in part, by a processing logic of a NSD, e.g., processing logic 120 of network switch 100 of FIG. 1. The processing logic may include any suitable CPU, FPGA, ASIC, finite state machine, etc., of the NSD. Some operations of method 600 may be performed by fixed-function units of the NSD (e.g., fixed function units 108 of network switch 100) and/or programmable units (e.g., programmable units 110 of network switch 100), or any combination thereof. Method 600 may be performed using an object code compiled with method 500. In some embodiments, the compiled object code may be installed on the NSD and may be executed by the processing logic using computer-readable instructions (e.g., non-transitory instructions) stored in memory of the NSD (e.g., memory 130 of network switch 100). Method 500 may be used to process any number of data packets using pipelined processing, parallel processing, or any combination thereof (e.g., using m parallel processing threads, each of the threads processing a separate pipeline of packets). Although a reference below may be made to a first data packet, a second data packet, and so on, it should be understood that the terms “first,” “second,” etc., are used herein as mere identifiers and do not necessarily presuppose any specific order of processing.

In some embodiments, method 600 may include receiving, at block 610, a first data packet. For example, the first data packet may be received via one (or multiple) ingress ports 102 shown in FIG. 1, from any one of computing devices connected to the NSD directly or via any type of a network. At block 620, method 600 may include generating a first (second, etc.) key value using at least one of i) a header of the first data packet or ii) a metadata generated by the NSD and associated with the first data packet. In some instances of unconditional actions, no key value may be generated. The first key value may be stored in any portion of any storage device of the NSD, e.g., in memory 130, registers 134, a storage for packet metadata 216, a fixed field storage 218 (both depicted in FIG. 2), and so on.

At block 630, method 600 may continue with executing, using one or more circuits of the NSD (e.g., processors, fixed-function units, programmable units, etc.), a first (second, etc.) plurality of PIs (e.g., MATs, groups of MATs, etc.), to select an action to be performed. For example, a first selected action may be selected from a first action and a second action and may be based on the first key value. Executing the first plurality of PIs may include accessing a first MAT. The first MAT may include a plurality of PI entries. More specifically, a first PI entry of the plurality of PI entries may specify the first action to be performed, the first action contingent on the first key value being equal to a first target value. Similarly, the second PI entry of the plurality of PI entries may specify a second action to be performed, the second action contingent on the first key value being equal to a second target value.

At block 640, method 600 may continue with performing the selected (e.g., first or second) action. Various contingent actions performed by the NSD may be any actions referenced above (e.g., in conjunction with method 500 of FIG. 5). At block 650, method 600 may determine if there are additional PIs (e.g., additional MATs) to process in relation to the first packet. If additional PIs are yet to be processed, operations of blocks 630 and 640 (and, in some instances, of block 620) may be repeated as many times as needed to process all pertinent MATs.

Some of the PIs may be a nested PI and may involve executing, using the one or more circuits of the NSD, a series of n MATs. A j-th MAT of the series of n MATs may include 2^{j} PI entries. The final (e.g., the n-th) MAT of the series of n MATs may include 2ⁿ PI entries that specify predicated execution of a respective one of the 2ⁿ contingent actions of the nested instruction. Additionally, any number of other actions may be specified by each intermediate j-th MAT (with j<n).

It should be understood that the above example of a nested PI is merely one illustrative implementation and that other ways of executing nested operations are possible. For example, a single MAT with various possible nested conditions may be used to execute such operations with various key combinations specified in various entries of the single MAT. Alternatively, any number of MATs (e.g., between 1 and n) may be used to represent the nested PI with various key combinations distributed among multiple MATs. In some embodiments, any of the n MATs may contain fewer than 2^{j} entries, e.g., if the source code does not contain a fully populated graph of all conditional branches. In some embodiments, one or more additional MATs may be interspersed throughout the series of the n MATs. These additional MATs may be used to calculate key values for use of subsequent PIs/MATs, for convenience of implementing a program via multiple instructions, located in separate MATs, and the like.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any appropriate nonempty subset of set of A and B and C. For instance, in illustrative example of a set having three members, conjunctive phrases “at least one of A, B, and C” and “at least one of A, B and C” refer to any appropriate of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any appropriate device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method to generate an object code configured to operate a network switching device (NSD), the method comprising:
obtaining a source code;
identifying a plurality of conditional instructions (CIs) in the source code, each of the plurality of CIs specifying one or more contingent actions to be performed by the NSD on a data packet; and
compiling the plurality of CIs to generate a plurality of sets of predicated instructions (PIs) of the object code executable by the NSD, wherein each of the plurality of sets of PIs corresponds to a respective one of the plurality of CIs.

2. The method of claim 1, wherein a first set of the plurality of sets of PIs comprises a first match action table (MAT), wherein the first MAT comprises:
a first identification of a key (first keyID); and
a plurality of PI entries, a first PI entry of the plurality of PI entries specifying a first action to be performed by the NSD, wherein the first action is contingent on a first key value identified by the first keyID being equal to a first target value.

3. The method of claim 2, wherein the first MAT further comprises:
a second PI entry of the plurality of PI entries specifying a second action to be performed by the NSD, wherein the second action is contingent on the first key value being equal to a second target value.

4. The method of claim 2, wherein the first MAT further comprises:
a second identification of a key (a second keyID); and
wherein the first action is further contingent on a second key value, identified by the second keyID, being equal to a second target value.

5. The method of claim 2, wherein the first keyID identifies a portion of a memory of the NSD, and wherein the first key value is a value currently stored in the identified portion of the memory of the NSD.

6. The method of claim 5, wherein the first key value currently stored in the identified portion of the memory of the NSD is obtained using at least one of i) a header of the data packet or ii) a metadata generated by the NSD and associated with the data packet.

7. The method of claim 2, further comprising:
identifying an unconditional instruction in the source code, the unconditional instruction specifying one or more unconditional actions to be performed by the NSD;
compiling the unconditional instruction to generate a second MAT that comprises:
a null identification of a key; and
a PI entry specifying the one or more unconditional actions to be performed by the NSD.

8. The method of claim 2, wherein the first action to be performed comprises at least one of:
a forwarding of the data packet;
a rejection of the data packet;
a modification of the data packet;
a generation of a register value based on the data packet; or
a generation of a notification about arrival of the data packet.

9. The method of claim 1, wherein the plurality of conditional instructions in the source code comprise:
an n-level nested CI specifying 2ⁿ contingent actions to be performed, in alternative, by the NSD, wherein n>1; and
wherein compiling the plurality of conditional instructions comprises:
compiling the n-level nested CI to generate one or more match action tables (MATs) collectively comprising 2ⁿ of fewer PI entries, wherein each of the 2ⁿ PI of fewer entries specifies predicated execution of one or more of the 2ⁿ contingent actions.

10. A method to operate a network switching device (NSD), the method comprising:
receiving, by the NSD, a first data packet;
generating a first key value using at least one of i) a header of the first data packet or ii) a metadata generated by the NSD and associated with the first data packet;
executing, using one or more circuits of the NSD, a first plurality of predicated instructions (PIs), to select, based on the first key value, an action from at least a first action or a second action; and
performing the selected action.

11. The method of claim 10, wherein executing the first plurality of PIs comprises accessing a first match action table (MAT), wherein the first MAT comprises:
a plurality of PI entries, a first PI entry of the plurality of PI entries specifying the first action to be performed by the NSD, wherein the first action is contingent on the first key value being equal to a first target value.

12. The method of claim 11, wherein the first MAT further comprises:
a second PI entry of the plurality of PI entries specifying the second action to be performed by the NSD, wherein the second action is contingent on the first key value being equal to a second target value.

13. The method of claim 11, wherein the first action comprises at least one of:
a forwarding of the first data packet;
a rejection of the first data packet;
a modification of the first data packet;
a generation of a register value based on the first data packet; or
a generation of a notification about arrival of the first data packet.

14. The method of claim 10, further comprising:
receiving, by the NSD, a second data packet;
executing, using the one or more circuits of the NSD, one or more match action tables (MATs) collectively comprising 2ⁿ or fewer PI entries, and wherein each of the 2ⁿ or fewer PI entries specifies predicated execution of one or more of the 2ⁿ contingent actions.

15. A system comprising:
a memory device; and
a processing device communicatively coupled to the memory device, the processing device configured to:
obtain a source code;
identify a plurality of conditional instructions (CIs) in the source code, each of the plurality of CIs specifying one or more contingent actions to be performed by a network switching device (NSD) on a data packet; and
compile the plurality of CIs to generate a plurality of sets of predicated instructions (PIs) of the object code executable by the NSD, wherein each of the plurality of sets of PIs corresponds to a respective one of the plurality of CIs.

16. The system of claim 15, wherein a first set of the plurality of sets of PIs comprises a first match action table (MAT), wherein the first MAT comprises:
a first identification of a key (first keyID); and
a plurality of PI entries, a first PI entry of the plurality of PI entries specifying a first action to be performed by the NSD, wherein the first action is contingent on a first key value identified by the first keyID being equal to a first target value.

17. The system of claim 15, wherein the first MAT further comprises:
a second PI entry of the plurality of PI entries specifying a second action to be performed by the NSD, wherein the second action is contingent on the first key value being equal to a second target value.

18. The system of claim 15, wherein the first MAT further comprises:
a second identification of a key (a second keyID); and
wherein the first action is further contingent on a second key value, identified by the second keyID, being equal to a second target value.

19. The system of claim 15, wherein the first keyID identifies a portion of a memory of the NSD, and wherein the first key value is a value currently stored in the identified portion of the memory of the NSD and is obtained using at least one of i) a header of the data packet or ii) a metadata generated by the NSD and associated with the data packet.

20. The system of claim 15, wherein the first action to be performed comprises at least one of:
a forwarding of the data packet;
a rejection of the data packet;
a modification of the data packet;
a generation of a register value based on the data packet; or
a generation of a notification about arrival of the data packet.

21. The system of claim 20, wherein the plurality of conditional instructions in the source code comprise:
an n-level nested CI specifying 2ⁿ contingent actions to be performed, in alternative, by the NSD, wherein n>1; and
wherein compiling the plurality of conditional instructions comprises:
compiling the n-level nested CI to generate one or more match action tables (MATs) collectively comprising 2ⁿ PI or fewer entries, wherein each of the 2ⁿ or fewer PI entries specifies predicated execution of one or more of the 2ⁿ contingent actions.

22. A non-transitory machine-readable storage medium comprising instructions that, when accessed by a processing device, cause the processing device to generate an object code by performing operations comprising:
obtaining a source code;
identifying a plurality of conditional instructions (CIs) in the source code, each of the plurality of CIs specifying one or more contingent actions to be performed by a network switching device (NSD) on a data packet; and
compiling the plurality of CIs to generate a plurality of sets of predicated instructions (PIs) of the object code executable by the NSD, wherein each of the plurality of sets of PIs corresponds to a respective one of the plurality of CIs.

23. A non-transitory machine-readable storage medium comprising instructions that, when accessed by a processing device of a network switching device (NSD), cause the processing device to perform operations comprising:
receiving, by the NSD, a first data packet;
generating a first key value using at least one of i) a header of the first data packet or ii) a metadata generated by the NSD and associated with the first data packet;
executing, using one or more circuits of the NSD, a first plurality of predicated instructions (PIs), to select, based on the first key value, an action from at least a first action or a second action; and
performing the selected action.
